(19) United States
(12) Patent Application Publication
(10) Pub. No.: US 2023/0137926 A1
(43) Pub. Date: May 4, 2023

(54) SYSTEM FOR MEASURING MICROBENDS AND ARBITRARY MICRODEFORMATIONS ALONG A THREE-DIMENSIONAL SPACE

(71) Applicant: OFS Fitel, LLC, Norcross, GA (US)

(72) Inventors: Raja A Ahmad, South Bound Brook, NJ (US); Paul S Westbrook, Bridgewater, NJ (US)

(73) Assignee: OFS Fitel, LLC, Norcross, GA (US)

(21) Appl. No.: 17/911,071

(22) PCT Filed: Mar. 15, 2021
(86) PCT No.: PCT/US21/22051

§ 371 Date: Sep. 12, 2022

Related U.S. Application Data
(60) Provisional application No. 62/989,117, filed on Mar. 13, 2020.

(51) Int. Cl. G01B 11/16; G01D 5/353

(52) U.S. Cl. CPC G01B 11/161; G01D 5/35316; G01D 5/35358

(57) ABSTRACT

A system for sensing microbends and micro-deformations in three-dimensional space is based upon a distributed length optical fiber formed to include a group of offset cores disposed in a spiral configuration along the length of the fiber, each core including a fiber Bragg grating that exhibits the same Bragg wavelength. A micro-scale local deformation of the multicore fiber produces a local shift in the Bragg wavelength, where the use of multiple cores allows for a complete micro-scale modeling of the local deformation. Sequential probing of each core allows for optical frequency domain reflectometry (OFDR) allows for reconstruction of a given three-dimensional shape, delineating location and size of various microbends and micro-deformations.

### CROSS-REFERENCE TO RELATED APPLICATIONS

This application claims the benefit of U.S. Provisional Application No. 62/989,117, filed Mar. 13, 2020 and hereby incorporated by reference.

### TECHNICAL FIELD

The present invention relates to an optical fiber-based distributed sensor and, more particularly, to a multicore fiber-based sensor that is able to detect the presence of microbends along the extent of a given fiber, providing three-dimensional information on the location and size of various deformations within a space surrounding the distributed sensor.

### BACKGROUND OF THE INVENTION

Optical fiber-based distributed sensors have emerged as an invaluable tool in performing characterizations of arbitrary deformations in three-dimensional space. Potential applications include 3D printing, surgical catheters, smart wearables, monitoring systems for fuel tanks, composite structures, and the like. The use of optical fibers for “shape sensing” offers high precision and high-speed operation, and may be particularly applicable for characterizing difficult-to-access surfaces and environments, as a result of the built-in shielding of the light beam that is used as the sensing probe.

To date, fiber-based distributed sensors have been able to reconstruct arbitrary paths and shapes only at the “macro” level (i.e., on a scale of centimeter/meter in terms of measurement). Going forward, the ability to perform distributed sensing at a smaller scale (i.e., sub-millimeter changes/bends) will become more important. For example, the influence of microbends on the attenuation of an optical communication signal propagating along a transmission fiber has been of interest for decades. As the transmission loss in optical fibers approaches the fundamental limits dictated by the intrinsic absorption and scattering in glass, the losses induced by the microscopic physical bends in the optical fibers (and cables) are becoming increasingly relevant. However, such microbends cannot be measured directly with the currently-available sensors.

### SUMMARY OF THE INVENTION

The needs remaining in the prior art are addressed by the present invention, which relates to a multicore fiber-based sensor that is able to detect the presence of microbends along the extent of a given fiber, providing three-dimensional information on the location and size of various deformations within a space surrounding the distributed sensor.

In accordance with the principles of the present invention, the ability to “reconstruct” micro-deformations that are distributed along the length of an optical fiber is provided by a system that is based on the use of a twisted multicore optical fiber to probe the distributed reflection of light within the multiple waveguiding cores. The cores are formed to include continuous fiber Bragg gratings (FBGs) that all exhibit the same Bragg wavelength. A micro-scale local deformation of the sensing fiber produces a local shift in the Bragg wavelength, where the use of multiple cores allows for a complete modeling of a bend at a specific location.

In one exemplary embodiment, the present invention takes the form of a distributed system for sensing and measuring microbends and micro-deformations in a three-dimensional (3D) space that utilizes a multicore sensing fiber in combination with an optical backscatter reflectometer. In particular, the multicore sensing fiber is formed to including a plurality of offset cores that are radially spaced from a center of the multicore sensing fiber by an amount Rₒ and a plurality of continuous fiber Bragg gratings (FBGs) inscribed in the plurality of offset cores in a one-to-one relationship. The set of FBGs are formed to reflect light at a common Bragg wavelength λ_{Bragg}. The optical backscatter reflectometer includes a tunable laser source for generating a swept wavelength output beam spanning a wavelength range surrounding λ_{Bragg}, an optical beam splitter/combiner, an optical detector, and a Fourier transform analyzer for performing optical frequency domain reflectometry (OFDR). The optical beam splitter/combiner functions to split the swept wavelength output beam from the tunable laser source into a swept wavelength “probe” beam that is directed into the multicore sensing fiber and a swept wavelength reference beam directed into a reflector. The optical beam splitter/combiner is also used for combining a swept wavelength return beam from the multicore sensing fiber and a reflected swept wavelength reference beam to create an interfering FBG sensing beam. The optical detector is responsive to the interfering FBG sensing beam for creating an electronic version of the interference beam, with the Fourier transform analyzer thereafter used to perform a Fourier transform on the electronic version of the interfering FBG sensing beam to generate measurements of local changes in Bragg wavelength along the length of the multicore sensing fiber and reconstruct therefrom the shape of the three-dimensional space.

While the sensor fiber may be formed of a conventional glass material, other embodiments may utilize a sensor fiber formed of a material that is less elastic, with a smaller Young's modulus that allows for an even finer degree of measurement resolution.

Other and further embodiments and features of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 is an isometric view of a section of twisted multicore optical fiber useful as a multicore sensing fiber in accordance with the present invention;

FIG. 2 is an end view of the multicore sensing fiber of FIG. 1;

FIG. 3 is a block diagram of an exemplary system for sensing and measuring deformations in three-dimensional space associated with the position of the multicore sensing fiber;

FIG. 4 is an enlarged cross-sectional view of a bend location along the multicore sensing fiber, illustrating the presence of both compression and expansion among various offset cores;

FIG. 5 is a graph depicting the reduction of standard deviation in fiber shape measurements as a function of the number of measurements that are taken; and

FIG. 6 illustrates an improvement in shape reconstruction associated with performing multiple measurements, where FIG. 6(a) is a photographic reproduction of a loop of multicore sensing fiber, FIG. 6(b) is a reconstruction based upon a single measurement, and FIG. 6(c) is a reconstruction based upon a set of ten separate measurements.

### DETAILED DESCRIPTION

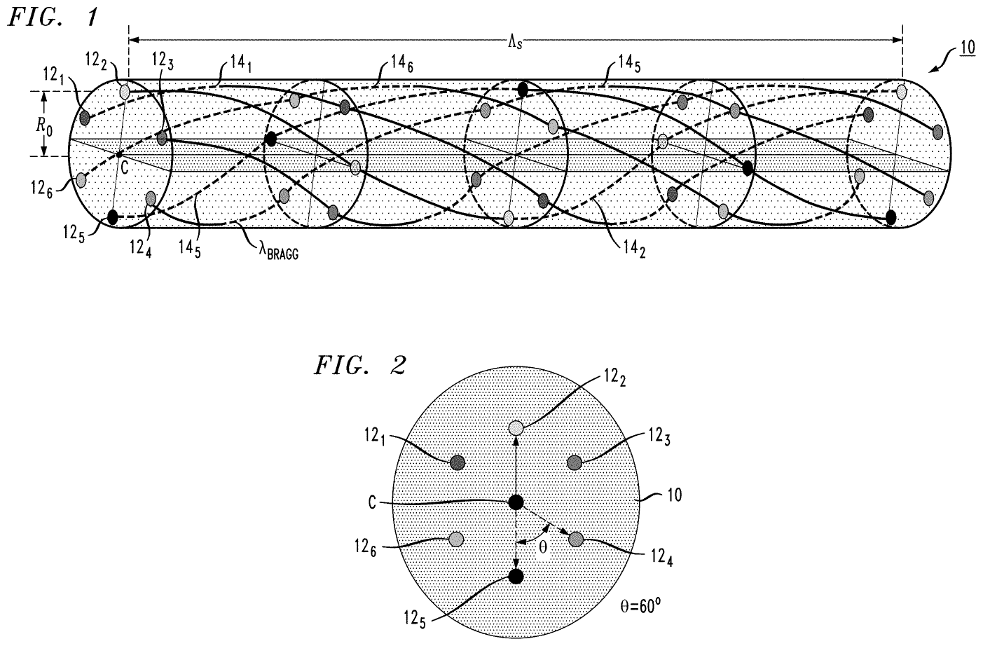

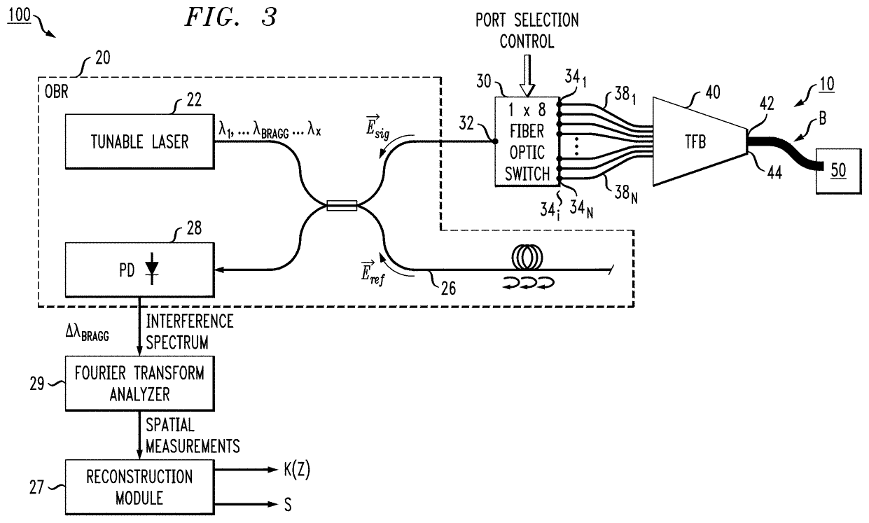

FIG. 1 is an isometric view of an exemplary twisted multicore optical fiber 10 that may be used to perform sensing of microbends (and various other micro-deformations in general) in three-dimensional space, in accordance with the principles of the present invention. FIG. 2 is an end-view of fiber 10 of FIG. 1, particularly illustrating the placement of a set of offset cores within multicore fiber 10. In this embodiment, multicore fiber 10 utilizes a set of six cores 12₁-12₆ that are all radially offset from the center C of fiber 10 by the same amount (Rₒ). As shown, the cores are equally spaced from one another, the set of six cores resulting in an angular displacement θ of 60° between adjacent cores.

As best shown in FIG. 1, sensing cores 12 follow a spiral pattern along the length of multicore fiber 10 (hence, the reference to “twisted” in describing the design of sensing fiber 10). Such a fiber may be formed during the process of drawing down an optical preform into the fiber, where the preform is continuously rotated, leading to offset cores 12 spiraling around the central axis of the fiber at a constant “twist frequency”. The defined twist frequency, which may be characterized as rotations per meter, thus forms a defined spatial twist period, denoted as Λₛ in FIG. 1.

Each offset core 12ᵢ is formed to include a continuous FBG 14ᵢ, which may be written in the cores during the process of drawing down the preform into the final fiber. Each FBG 14ᵢ is created to exhibit the same Bragg wavelength λ_{Bragg} so that they all reflect light of the same wavelength in the absence of any local bends or deformations that otherwise creates a shift in the Bragg wavelength value.

FIG. 3 illustrates an exemplary distributed shape sensing system 100 utilizing the multicore sensing fiber 10 of FIGS. 1 and 2. System 100 includes an optical backscatter reflectometer (OBR) 20 that utilizes optical frequency domain reflectometry (OFDR) measurements in a manner fully described below to ascertain the presence of micro-deformations along multicore sensing fiber 10, providing detailed information about their location and shape. The ability to collect measurements from multiple offset cores 12 at any transverse position along the extent of multicore sensing fiber 10 provides the resolution necessary to provide highly accurate sensing of microbends in the fiber.

OBR 20 itself includes a tunable laser source 22 that is configured as a swept wavelength (frequency) source, centered on the Bragg wavelength (λ_{Bragg}) of FBGs 14. In one exemplary embodiment, tunable laser source 22 may be configured to provide a narrow linewidth output that is swept through a wavelength range±10 nm on either side of λ_{Bragg} (i.e., a wavelength range of 20 nm). For example, if λ_{Bragg}=1541 nm, tunable laser source may be configured to provide an output beam that is scanned across the wavelength range of 1531 nm to 1551 nm. The tunable bandwidth of 20 nm is exemplary only, and there are instances where a larger bandwidth may be desirable, as discussed below.

The output beam from tunable laser 22 thereafter passes through a beam splitter 24 of OBR 20, which directs a majority of the beam (referred to at times as a “probe beam” or “probe signal”) out of OBR 20 and into a 1×N optical switch 30. Switch 30 is controlled to direct the probe beam into a selected offset core 12ᵢ of multicore sensing fiber 10 in a manner that will be described in detail below.

Returning to the description of OBR 20, the remaining output from beam splitter 24 (referred to at times as a “reference beam”) is directed along a reflective signal path 26. The reflected reference beam and backscattered reflections from multicore sensing fiber 10 are combined within beam splitter 24 (operating as a combiner in this direction), directing the interfering combination of these signals into an optical detector 28 included within OBR 20. The output from optical detector 28 is thereafter applied as an input to Fourier analyzer 29, which performs frequency domain analysis, converting the frequency domain measurement from optical detector 28 into a space-domain measurement of phase and amplitude as a function of length along multicore sensing fiber 10.

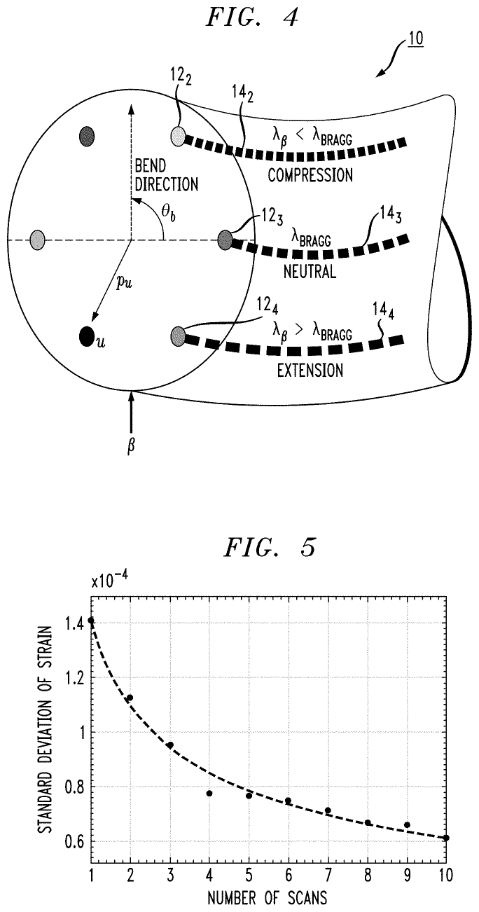

If multicore sensing fiber 10 is flat and straight with no microbends (or other types of micro-deformations), FBGs 14 will all maintain the reference Bragg wavelength λ_{Bragg} and will consistently reflect probe beam light at only this wavelength, allowing the remaining wavelengths to continue to propagating along multicore sensing fiber 10. Therefore, inasmuch as there is no change in λ_{Bragg}, there is also no change in the frequency component of the output from optical detector 28. Thus, Fourier analyzer 29 provides a constant, linear output signal indicative of an “unperturbed” multicore sensing fiber 10. Once any microbend/deformation is present within fiber 10, the Bragg wavelength of one or more offset cores 12 will change (see FIG. 4, discussed below), and the output from Fourier analyzer 29 will contain a set of peaks associated with the microbend. The output from Fourier analyzer 29 may be considered as the output sensing signal from OBR system 20.

Therefore, in accordance with the principles of OFDR, by illuminating each offset core 12ᵢ with a probe beam that is scanned across the defined wavelength range, deformations/microbends along multicore sensing fiber 10 will be identified within the interference signal processed by Fourier analyzer 29. That is, by performing a Fourier transformation of the interfering beams, the spectral information can be used to detect and measure micro-deformations along multicore sensing fiber 10. The Fourier transform converts the spectral information in the received interference signal into spatial (temporal) information, depicted in the form of distributed Bragg wavelength changes at locations where microbends/deformations are present.

The Fourier relation inversely relates the wavelength scanning range of tunable laser source 22 to the longitudinal spatial domain measurements of strain (and, therefore, of curvature and shape). For example, a 20 nm wavelength scanning range translates into a 40 μm measurement resolution. Increasing the wavelength scanning range to 80 nm (still centered on the defined Bragg wavelength) translates into a 10 μm resolution in the measurement of local microbends, albeit at the cost of requiring a tunable laser source 22 that is capable of generating such a large swept wavelength range.

Continuing with the description of the components of system 100, the tunable probe beam exiting OBR 20 is provided as an input to 1×N optical switch 30, as mentioned above. Optical switch 30 includes a single input/output port 32 and a plurality of N connecting ports 34₁-34_{N}, with each connecting port 34ᵢ associated with a unique offset core 12ᵢ. The plurality of N outputs from optical switch 30 are coupled into a plurality of separate optical fibers 38₁-38_{N}, which are associated with offset cores 12₁-12_{N} in a one-to-one relationship. The far end of multicore sensing fiber 10 is immersed in an index-matching gel 50 to suppress unwanted Fresnel reflections at the far endface of fiber 10 from re-entering one or more of the multiple offset cores 12.

FIG. 3 also illustrates an exemplary arrangement for coupling the outputs from optical switch 30 to multicore sensing fiber 10. In particular, FIG. 3 shows the use of a tapered fiber bundle (TFB) 40 to provide an efficient optical coupling between fibers 38 (from optical switch 30) and offset cores 12 of fiber 10. In accordance with the known principles of operation of a given TBF, TBF 40 functions to reduce the overall diameter of the “bundle” of input fibers 38 into an output taper 42 that matches an endface of multicore sensing fiber 10 (as shown in FIG. 2, described above). Output taper 42 is oriented such that the core regions of each fiber 38 align with a separate one of offset cores 12. That is, the cross-sectional geometry of an output endface 44 of TBF 40 is matched to the endface of multicore sensing fiber 10 as shown in FIG. 2. The use of TBF 40 allows for an efficient launch of probe signal into, as well as the collection of backscattered signal from, multicore sensing fiber 10.

System 100 as shown in FIG. 3 is used to recognize microbends along multicore sensing fiber 10 by the local asymmetric stress created within the fiber cross-section at the location of given microbend B. FIG. 4 is an enlarged, cut-away isometric view of multicore sensing fiber 10 at a particular location B experiencing deformation. This particular bend results in putting core 12₂ into compression and thus decreasing the spacing between adjacent gratings in FBG 14₂. In accordance with the known properties of Bragg gratings, this decrease in the grating period also decreases the Bragg wavelength experienced by FBG 14₂. Core 12₃ is unaffected by this bend, since it is at the neutral plane of fiber 10 (as illustrated in FIG. 4), and therefore the Bragg wavelength of FBG 143 remains constant. Core 124 experiences extension at this bend location, which widens the space between adjacent gratings forming FBG 144, reducing the grating period and the Bragg wavelength of FBG 144.

By using optical switch 30 to sequentially illuminate each individual offset core 12ᵢ with the swept wavelength probe beam, the changes in Bragg wavelength associated with specific cores at a given transverse location thus allows for the type of shape deformation to be re-created. That is, the inclusion of the switching capability within system 100 allows for the collection of data from multiple offset cores 12 on a one-by-one basis so as to obtain cross-sectional deformations at selected locations along fiber 10. Repeating this process along the extent of multicore sensing fiber 10 allows for a complete reconstruction of various microbends (and other types of deformations) that occur along its span.

Once all of the measurements have been completed by Fourier analyzer 29, the distributed curvature and shape of the associated three-dimensional space may be created by a reconstruction module 27 that is coupled to the output of Fourier analyzer 29, as shown in FIG. 3. The distributed curvature of multicore sensing fiber 10 is a vector quantity, κ(z), and its phase offers information about the direction of the local microbend, which aids in the reconstruction of the distributed shape of sensing multicore fiber 10. In general, the spatially-dependent curvature κ(z) depends on the local strain and the geometry of offset cores 12, where

$$κ ( z ) = \frac{1}{{R}_{o}} {\sum }_{u = 1}^{N} {ρ}_{u} ( z ) {ε}_{u} ( z ) ,$$

where Rₒ is the radial offset between the center of fiber 10 and the center of an offset core 12ᵤ, u defines the individual cores, εᵤ(z) is the unit vector of the respective core 12ᵤ, and εᵤ(z) is the strain induced in the corresponding core 12ᵤ. Using the strain-optic coefficient η of silica glass (˜0.78) and measured local changes in Bragg wavelength Δλ_{Bragg} recorded by Fourier analyzer 29, the corresponding local strain εᵤ(z) experienced by core u can be defined by reconstruction module 29 as:

$${ε}_{u} ( z ) = \frac{1}{η} \frac{{Δλ}_{Bragg , u}}{{λ}_{Bragg}} .$$

By utilizing optical switch 30 to sequentially illuminate each offset core 12₁-12_{N}, the strain information from the plurality of N (for example, N=6) offset cores 12 is summed within reconstruction module 29 in the manner shown in the definition of spatially-dependent curvature κ(z), developing both the magnitude and phase of the distributed fiber curvature. The bend orientation of each curve along multicore sensing fiber 10 is represented by the phase portion of the curvature. It is to be understood that the number of individual offset cores 12 included within multicore sensing fiber 10 directly impacts the accuracy of the calculated distributed curvature, where increasing the number of offset cores will increase the amount of data that is captured and recorded by Fourier analyzer 29.

Finally, the distributed shape S of the deformed fiber may also be provided as an output from reconstruction module 27. In particular, the distributed shape is reconstructed from the calculated spatially-dependent curvature κ(z), using the Frenet-Serret formulas (which are a set of differential equations describing a three-dimensional (3D) curve) to provide the distributed shape output from module 27. Specifically, the Frenet-Serret equations relate the local shape parameters, including the tangent T(x,y,z), normal N(x,y,z) and binomial B(x,y,z) vectors, with the fiber curvature and torsion measured at the closely spaced locations. Mathematically, this is expressed as:

$$\dot{S} = [ \begin{matrix}0 & κ ( z ) & 0 \\ - κ ( z ) & 0 & τ ( z ) \\ 0 & - τ ( z ) & 0\end{matrix} ] S$$

where, S≡[T(x,y,z); N(x,y,z); B(x,y,z)], \dot{S}=dS/dz, and the torsion τ(z) quantifies how rapidly the bend direction changes along the length of the curved fiber. In practice, a spatial derivative of the phase component of the distributed curvature vector leads to the amount of torsion τ(z) (=dθ_{b}(z)/dz) produced along the length of multicore sensing fiber 10. By repeatedly solving this expression for the eigenvalues and eigenvectors of the set S along the length (z-axis) of multicore sensing fiber 10, the distributed shape of the fiber may be estimated.

It is important to note that the initial conditions for solving the above expression assume an absence of curvature and torsion at the location z=0 i.e., κ(0)=τ(0)=0 at the input to multicore sensing fiber 10. Furthermore, the tangent T(x,y,z), normal N(x,y,z) and binormal B(x,y,z) vectors, at z=0, are defined as the three orthonormal unit vectors in an arbitrarily chosen three-dimensional spatial frame-of-reference. The tangent vector at any position is assumed to be “pointing” in the direction of the increasing fiber length and indicates the local fiber direction. Therefore, a concatenation of the tangent vectors at closely spaced locations along the length of multicore sensing fiber 10 represents the distributed shape of the fiber.

The measurement sensitivity of the inventive system may be increased by increasing the signal-to-noise ratio (SNR) of OBR 20, or broadening the tuning wavelength range of tunable laser 22 to increase measurement resolution (as mentioned above). The SNR depends on the spectral beating signal generated by interfering the reference beam (\vec{E}ᵣ) with the backscattered signal (\vec{E}ₛ) in OBR 20. That is, SNR∝|\vec{E}ᵣ|×|\vec{E}ₛ|. Therefore, the SNR can be increased two-fold (for example) by increasing the intensity of tunable laser source 22, or by simply increasing by two-fold the amplitude of refractive index modulation Δn_{ac} of Bragg gratings 14, since|\vec{E}ₛ|∝n_{ac}. Reducing background noise present within the instrumentation of OBR 20 itself (e.g., shot-noise, dark current noise, frequency measurement noise, and the like) also increases the SNR of OBR 20 and, as a result, the measurement sensitivity of the system.

Increasing the sensitivity of measurements in the transverse plane of multicore sensing fiber 10 may also be provided by increasing the radial offset Rₒ between cores 12 and the central axis of fiber 10, while maintaining the same outer diameter of the fiber. The amount of Bragg wavelength shift (Δλ_{Bragg}) in the presence of bend-induced fiber strain is directly related to the value of Rₒ, as shown by the following relation:

$$\frac{{Δλ}_{Bragg}}{{λ}_{Bragg}} = η {R}_{o} {y}_{0} {k}_{d}^{2} ,$$

where η is a fixed quantity representing the strain-optic coefficient of the silica glass, y₀ is the amount of fiber displacement in the transverse plane with respect to a straight (flat) neutral plane, and k_{d} is the period of the deformation imposed along the length of the fiber. Clearly, the amount of detected wavelength shift can be increased by proportionately increasing the radial offset (i.e., Rₒ) of cores 12. This leads to a linear increase in the SNR of the system, which ultimately improves the sensitivity of the measurements.

Another alternative approach to increasing measurement sensitivity is to reduce the overall diameter of multicore sensing fiber 10. Since the fiber is cylindrical in form, reducing the diameter serves to lower the moment of inertia I (I=π/4*R⁴), where R is the radius of fiber 10. It follows that by lowering the moment of inertia, the flexibility (and thus bending) of multicore sensing fiber 10 itself is increased, providing a larger shift in Bragg wavelength in FBGs 14. The increase in I may improve the sensitivity of the local strain, the local curvature and, ultimately, the distributed shape measurements. Specifically, by reducing the fiber diameter by 50%, the value of I₅₀% is reduced to about 0.0625I and a factor of sixteen increase in both the resulting bend amplitude y₀ and associated Bragg wavelength shift Δλ_{Bragg}.

Fabricating multicore sensing fiber 10 from an optical material with a Young's modulus (E) less than that of conventional silica glass (E=˜70 GPa) also leads to improvements in SNR. Soft glasses, such as chalcogenide and fluoride glasses present suitable platforms for the reduced Young's modulus of multicore sensing fiber 10. On the other hand, the longitudinal sensitivity of the shape-sensing measurements can be increased proportionally by increasing the precision of the estimated group delay for the distributed backscatter signal. Using a set of distributed measurements of the refractive index of fiber 10 may be used to determine the estimated group delay.

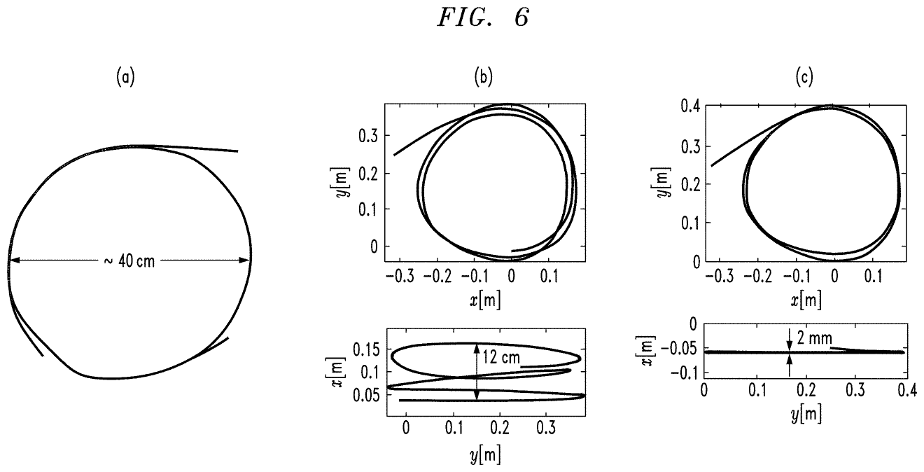

It has also been found that performing repeated measurements of each offset core allows for the noise present in the averaged values to be reduced. For example, switch 30 may be controlled to perform multiple switchings from port 34₁ through port 34_{N}, forming multiple measurement scans of multicore sensing fiber 10. That is, by performing multiple scans of each offset 12, the noise contribution associated with a single scan is reduced by averaging out over multiple scans. That is, the repeated measurements result in suppressing noise present in the measurement data by averaging the data over a number of scans, thereby effectively enhancing the SNR and improving the accuracy of the fiber shape measurement. FIG. 5 illustrates the reduction in the standard deviation of the strain measurements as a function of the number of averaging scans. A greater than 3 dB suppression in the standard deviation was observed when the data was averaged over 10 separate measurements. The effect of this multi-scan noise suppression has also been analyzed with respect to the accuracy of shape reconstruction.

FIG. 6(a) is a photo reproduction of an exemplary multicore sensing fiber that was bent into circular loops, with the loops having a diameter of about 40 cm. FIG. 6(b) is a reconstruction formed in accordance with the teachings of the present invention when only a single set of measurements was obtained (i.e., a single scan), while the reconstruction shown in FIG. 6(c) was obtained by averaging the results of 10 separate scans. The reconstructed shape of the fiber was found to exhibit a considerably higher error with respect to the actual layout of the fiber when the measurements were not averaged over multiple scans, clearly demonstrating the impact of noise. This is especially true under settings of mild bends and small curvatures, where the strain signal is not substantially larger than the noise.

It will be apparent to those skilled in the art that various modifications and variations can be made to the present invention without departing from the spirit or scope thereof. Thus, it is intended that the present invention cover the modifications and variations of the above-described embodiments, all of which are considered to fall within the spirit and scope of the invention as the defined by the claims appended hereto.

What is claimed is:

1. A distributed system for sensing and measuring microbends and micro-deformations in a three-dimensional (3D) space, comprising:
a multicore sensing fiber including
a plurality of offset cores that are radially spaced from a center of the multicore sensing fiber by an amount Rₒ; and
a plurality of continuous fiber Bragg gratings (FBGs) inscribed in the plurality of offset cores in a one-to-one relationship, each FBG formed to reflect light at a common Bragg wavelength λ_{Bragg}; and
an optical backscatter reflectometer including
a tunable laser source for generating a swept wavelength output beam spanning a wavelength range surrounding λ_{Bragg};
an optical beam splitter/combiner for splitting the swept wavelength output beam into a swept wavelength probe beam directed into the multicore sensing fiber and a swept wavelength reference beam directed into a reflector, the optical beam splitter/combiner also for combining a swept wavelength return beam from the multicore sensing fiber and a reflected swept wavelength reference beam to create an interfering FBG sensing beam;
an optical detector responsive to the interfering FBG sensing beam for creating an electronic version thereof; and
a Fourier transform analyzer coupled to the optical detector and utilizes to perform a Fourier transform on the electronic version of the interfering FBG sensing beam to generate measurements of local changes in Bragg wavelength along the length of the multicore sensing fiber and reconstruct therefrom the shape of the three-dimensional space.

2. The distributed system as defined in claim 1, wherein the plurality of cores is disposed in a spiral pattern along an axial length of the multicore sensing fiber, the spiral pattern being periodic with a defined period Λₛ.

3. The distributed system as defined in claim 1, further comprising
an optical switching arrangement disposed along a path of the swept wavelength probe beam for controlling coupling between the swept wavelength probe beam and the plurality of offset cores within the multicore sensing fiber.

4. The distributed system as defined in claim 3 wherein the optical switching arrangement comprises a 1×N optical switch and the plurality of offset cores comprises a plurality of N offset cores, the 1×N optical switch configured to provide coupling a plurality of N switch ports and the plurality of N offset cores in a one-to-one relationship.

5. The distributed system as defined in claim 4 wherein the 1×N optical switch is controlled to sequentially couple the swept wavelength probe beam to each switch port of the plurality of N switch ports so as to sequentially couple the swept wavelength probe beam to each offset core in sequence, performing a scanning sequence of the multicore sensing fiber over a period of time.

6. The distributed system as defined in claim 5 wherein multiple scans of each offset core are performed to reduce a signal-to-noise ratio in measurements generated by the Fourier transform analyzer.

7. The distributed system as defined in claim 4, further comprising a tapered fiber bundle disposed between the output of the 1×N optical switch and an input endface of the multicore sensing fiber, the tapered fiber bundle reducing a physical size of the plurality of output fibers exiting the 1×N optical switch into a diameter essentially equivalent to a diameter of the multicore sensing fiber.

8. The distributed system as defined claim 1, further comprising a reconstruction processor for determining a distributed curvature κ(z) in the three-dimensional space, the distributed curvature being a vector quantity with a phase providing information about directions of local microbends and the distributed curvature is defined as:
$$κ ( z ) = \frac{1}{{R}_{o}} {\sum }_{u = 1}^{N} {ρ}_{u} ( z ) {ε}_{u} ( z ) ,$$
where Rₒ is the radial offset between the center of the multicore sensing fiber and a center of an offset core, u defines an individual core, ρᵤ(z) is a unit vector of the associated offset core, and εᵤ(z) is a strain induced in the associated offset core and is defined as follows:
$${ε}_{u} ( z ) = \frac{1}{η} \frac{{Δλ}_{Bragg , u}}{{λ}_{Bragg}} ,$$
where η is a strain-optic coefficient associated with a composition of the multicore sensing fiber.

9. The distributed system as defined in claim 8 wherein the reconstruction processor is further configured to determine a distributed shape S of the three-dimensional space, based upon the determined distributed curvature vector κ(z) and defined as follows:
$$\dot{S} = [ \begin{matrix}0 & κ ( z ) & 0 \\ - κ ( z ) & 0 & τ ( z ) \\ 0 & - τ ( z ) & 0\end{matrix} ] S$$
where, S≡[T (x,y,z); N(x,y,z); B(x,y,z)], T(x,y,z), is a tangent of the distributed curvature vector, N(x,y,z) is a normal of the distributed curvature vector, B(x,y,z) is a binomial of the distributed curvature vector, \dot{S}=dS/dz, and τ(z) denotes a torsion and quantifies how rapidly a bend direction changes along a length of the multicore sensing fiber.

10. The distributed system as defined in claim 1 wherein Rₒ is selected to provide a desired change in Bragg wavelength Δλ_{Bragg} in the presence of a deformation, where
$$\frac{{Δλ}_{Bragg}}{{λ}_{Bragg}} = η {R}_{o} {y}_{0} {k}_{d}^{2} ,$$
and where η is a fixed quantity representing a strain-optic coefficient of a material forming the multicore sensing fiber, y₀ is an amount of local displacement in a transverse plane of the deformation with respect to a straight neutral plane, and k_{d} is a period of the deformation imposed along a length of the multicore sensing fiber.

11. The distributed system as defined in claim 10 where Rₒ is at least 35 μm in a multicore sensing fiber having an outer diameter D of about 200 μm.

12. The distributed system as defined in claim 1 wherein an improved measurement sensitivity is provided by maintaining a relatively small outer diameter of the multicore sensing fiber, associated with an increased inertia and tendency to exhibit a relatively large change in Bragg wavelength in the presence of a deformation.

13. The distributed system as defined in claim 1 wherein the tunable laser source exhibits a tunable wavelength range of at least 20 nm, providing a measurement resolution of about 40 μm.

14. The distributed system as defined in claim 13 wherein the tunable laser source exhibits a tunable wavelength range of about 80 nm, providing a measurement resolution of about 10 μm.

15. The distributed system as defined in claim 1 wherein the plurality of offset cores comprises a set of six cores, with a separation of 0=60° between adjacent cores.

16. The distributed system as defined in claim 1 wherein the multicore sensing fiber comprises a silica material having a Young's modulus E of about 70 GPa.

17. The distributed system as defined in claim 1 wherein the multicore sensing fiber comprises a soft glass material with a Young's modulus less than the Young's modulus of silica.

18. The distributed system as defined in claim 17 wherein the soft glass material is selected from the group consisting of chalcogenide and fluoride.
